(19) United States
(12) Patent Application Publication
(10) Pub. No.: US 2007/0166403 A1
(43) Pub. Date: Jul. 19, 2007

(54) Method and Compound for Treating Mold

(75) Inventor: Blaise McArdle, Bethlehem, PA (US)

Correspondence Address: EDELL, SHAPIRO & FINNAN, LLC, 1901 RESEARCH BOULEVARD, SUITE 400, ROCKVILLE, MD, 20850, US

(73) Assignee: Amino Solutions, LLC, Rockville, MD (US)

(21) Appl. No.: 11/621,293

(22) Filed: Jan. 9, 2007

Related U.S. Application Data
(60) Provisional application No. 60/757,884, filed on Jan. 11, 2006.

(51) Int. Cl. A01N 59/08; A01N 37/18

(52) U.S. Cl. 424/661; 514/2

(57) ABSTRACT

A compound that both kills mold and prevents mold re-growth contains a mold killing disinfectant and a film-forming substance that forms a film layer on the treated surface for retaining the mold killing disinfectant in place. The film-forming substance preferably includes a prolamine. The preferred disinfectant includes iodine and a bleaching agent containing sodium hypochlorite.

### CROSS REFERENCE TO RELATED APPLICATION

This application claims priority from U.S. Provisional Patent Application Ser. No. 60/757,884 entitled “Method and Compound For Treating Mold,” filed Jan. 11, 2006. The disclosure of this provisional patent application is incorporated herein by reference in its entirety.

### FIELD OF THE INVENTION

The present invention pertains to methods and compounds for treating mold (e.g., microbes, fungus, etc.) and, more particularly, to inhibiting mold growth, remediating existing mold growth and cleaning mold-covered surfaces and structures.

### BACKGROUND OF THE INVENTION

Mold can be found almost anywhere. It can grow on virtually any organic surface as long as moisture and oxygen are present in the ambient environment. Mold can seriously impair the health of humans and animals that come into contact with or ingest (e.g., by inhaling the spores) mold. More particularly, all molds have the potential to cause adverse health effects, such as by producing allergens that can trigger allergic reactions or asthmatic attacks in people allergic to molds. Other molds are known to produce toxins and/or irritants.

In addition, molds can damage structures, plants and other things. Specifically, molds reproduce by making microscopic spores that often waft through indoor and outdoor air. When mold spores land on a damp spot indoors they may begin growing and then digesting whatever material they are growing on. Even if such mold is ultimately killed, the material that has been digested must be repaired or replaced.

Many products for killing mold have been developed and sold. Some are effective for the purpose, others are not. However, there is no product or method that is effective in both killing (i.e., remediating) and preventing re-growth of mold; nor is there a product or method that, in addition to prevention and remediation, cleans the affected surface.

It is therefore desirable to provide a method and means for preventing mold growth, remediating existing mold growth and cleaning surfaces on which mold may have grown.

### SUMMARY OF THE INVENTION

In one aspect, the present invention utilizes a combination of materials, preferably in a sprayable solution or viscous paste, comprising one or more disinfectant elements and/or compounds combined with a salt and a film-forming material such as a tackifier that allows the materials to adhere to the treated surface by forming a film that remains intact even if that surface is rubbed or scratched. In addition, the combination may include: a surfactant agent to prevent exposure of the other materials in the combination to air that might alter the materials; a pH stabilizer and a suitable solvent. Although the combination appears to be most effective when in a sprayable or brushed-on liquid form, it may also be constituted as a paste, a gel or a powder. In addition, when sold as a powder, gel or paste, it may be mixed in a water solution by the end user for application as a spray. Moreover, when the combination is in liquid form, it may be applied in methods other than spraying, such as by pouring, dabbing, any liquid applicator, etc.

In a second aspect of the present invention, mold remediation is achieved by the synergistic interaction of iodine and a bleach (e.g., containing sodium hypochlorite), both serving as disinfectants, applied in a composition that kills mold on contact.

In a third aspect of the present invention, one or more disinfectants that is/are operative to kill mold is/are rendered long lasting mold preventative(s) by combining it/them with a tackifier that forms a protein barrier film on the treated surface that establishes a waterproof protective layer that maintains the disinfectant(s) active to inhibit further growth of mold.

The above and still further features and advantages of the present invention will become apparent upon consideration of the following definitions and descriptions of specific embodiments thereof. While these descriptions go into specific details of the invention, it should be understood that variations may and do exist and would be apparent to those skilled in the art based on the descriptions herein.

### DESCRIPTION OF THE PREFERRED EMBODIMENTS

The following detailed explanations of the preferred embodiments reveal the methods and compounds of the present invention.

In one preferred embodiment of the invention, the disinfectant is iodine in the form of iodine resublime, the salt is sodium chloride as found in nature with numerous trace minerals, and the tackifier is a complex formed from a protein, a saccharide, an alkali metal or alkaline earth metal salt and an acid. In the preferred embodiment, the protein in the tackifier is preferably a prolamine, most preferably zein; the saccharide is preferably a polysaccharide, most preferably guar gum; the salt is preferably sodium chloride, most preferably sodium chloride with trace amounts of magnesium chloride and calcium chloride; and the acid is preferably an organic acid, most preferably at least one of citric acid and ascorbic acid. In general, the tackifier may take the form of any of the protein-saccharide complexes disclosed in my U.S. Pat. Nos. 5,514,412 and 6,197,199, the entire disclosure of which is incorporated herein by reference. I have found that the following formulation, with constituents shown by percent volume present, and formulated as a liquid spray, functions to kill all tested fungi and microbes on a treated surface, to prevent re-growth of those fungi and microbes for at least 18 months, and to prevent initial formation of molds on the treated surface:
A. Iodine resublime: 0.02%—serving as a disinfectant (i.e., anti-bacterial, anti-fungal and mold spore killing agent).
B. Isopropyl alcohol: 0.98%—serving as both a disinfectant and a solvent.
C. Tackifier: 0.01% comprising:
   (1) guar gum—96.71% (by volume of the tackifier)
   (2) zein—0.49%
   (3) Salt (NaCl)—0.10%
      (plus trace minerals found in natural salt)
   (4) citric acid—2.70%
D. Naturally occurring Sodium Chloride: 7.50%—serving with its various trace minerals as a dosing agent for the constituents of the formulation to maintain the constituents in chemical balance
E. Sodium Hypochlorite: 1.80%—serving as a disinfectant.
F. Sodium lauryl sulfate: 1.00%—serving as a reforming surfactant agent that prevents exposure of the salts to air, thereby preventing alteration of the materials in the formulation.
G. Sodium tetraborate: 2.08%—serving as a disinfectant and pH stabilizer
H. Water: 86.61%—serving as a solvent for the sprayable solution.

Other formulations using the principles described herein have been shown to be effective in killing mold and preventing growth or re-growth on the treated surface. For example, a second preferred formulation comprises (with percentages by volume of the formulation indicated):

| | |
|---|---|
| Iodine in Solution with Isopropyl Alcohol (70% IPA) | 1.06% |
| (2% Iodine Resublime) | |
| Tackifier (As described above) | 0.01% |
| Saturated Sodium Chloride | 31.91% |
| (Untreated Salt in water solution) | |
| Sodium Hypochlorite (NaOCl) | 31.91% |
| (Bleach - 6% concentration) | |
| Sodium Lauryl Sulfate (e.g. in Dishwashing Soap | 3.2% |
| such as Joy ®; Palmolive ®; etc.) | |
| Saturated Sodium Tetraborax | 31.91% |
| (Borax Solution in Water) | |

A suitable procedure for making this second embodiment is as follows:
Pre-Mix of Components:
1. 2% Iodine Resublime Solution—Combine 0.2% of iodine resublime with 9.8 ml of 70% IPA. Agitate vigorously using electric mixer or blender in closed container until dissolved as fully as possible. Strain off residue and set aside.
2. Saturated Salt Solution—Prepare solution by adding 75 ml of untreated salt to 300 ml of hot tap water. Mix until untreated salt has completely dissolved. Allow solution to cool.
3. Borax Solution—Prepare solution by dissolving 18.75 grams of borax in 300 ml of hot tap water. Allow to cool.
   Preparation of Formulation:
A) To 300 ml of the saturated salt solution add 300 ml (300 grams) of sodium hypochlorite. Insure that the bleach is 6% concentration. Blend until mixture is uniform.
B) Add 0.1 grams of tackifier and stir/mix vigorously at approximately 500 rpm for approximately 2 minutes or as long as necessary to ensure that the tackifier has dissolved in the saturated salt and bleach solution.
C) Add 10 ml of the 2% iodine solution and continue to stir rapidly until mixture is uniform.
D) Add 300 ml of the borax solution and blend vigorously until mixture is uniform.
E) Add 30 grams of the dishwashing soap to the blend; reduce agitation to approximately 20 rpm and mix for approximately 2 minutes. Blend until gelling is eliminated.
F) Add additional tap water as needed to make 1 liter.
G) Store finished product at room temperature.

The primary constituents used in the manufacture of the described embodiments include iodine, natural sodium chloride, sodium hypochlorite, sodium lauryl sulfate, sodium tetraborate, and a seed prolamine protein powder in an alcohol/acid solvent (i.e. the tackifier) that is dispersed over a massive organic or inorganic surface. The materials can be mixed and blended in various lot/batch sizes. The iodine is saturated with IPA prior to introducing the iodine into the solution. The sodium chloride and sodium tetraborate are saturated with water prior to introduction into the solution. The sodium hypochlorite and saturated sodium chloride are combined to form the base of the solution. The sodium lauryl sulfate can be added as a liquid or powder. The seed prolamine protein is acidified and pulverized prior to mixing into the other ingredients.

To expand on what has been described above, the iodine serves as an anti-bacterial and anti-fungal agent; notably iodine by itself is not generally considered to be effective to inhibit, remediate or clean mold. The sodium chloride forms salts, and also evolves into small amounts of chlorine gas that is destructive to mold and bacteria. The sodium chloride is also a carrier that releases nutrients that are beneficial in sustaining, on the treated surface, the protein barrier film (described below) that retains all of the anti-microbial effects of the formulation on the treated surface over time. The sodium hypochlorite serves as an anti-microbial agent in that it shocks the mold, makes it susceptible to breakdown, and kills it. The ionic, catonic and/or non-ionic sodium lauryl sulfate acts as a surfactant that cleans and penetrates mold and prevents mold from forming. The sodium tetraborate acts as an additional disinfectant against mold. The seed prolamine powder holds all of the ingredients in a proper order and creates a protein barrier film on the treated surface that establishes a waterproof protective layer that inhibits further growth of mold. The IPA serves as a solvent that opens up the alcohol composition of the protein and allows the iodine to be completely absorbed by the protein.

When the formulation/solution is applied at an elevated pH to mold, the mold is immediately broken down into simple building blocks. As the mold is broken down it becomes saturated with several salts, and the proteins from the basic amino acid groups found in the solution form a film layer to prevent the mold from reforming. If the mold attempts to form with any other particular pH of one of the ingredients, the other ingredients create a protective pH and prevent the mold from reforming. Over time, as the mold continually attempts to reform itself, the proteins and enzymes released by the amino acid groups, and retained on the surface by the film layer, attack the mold, break it down and eliminate the possibility of it reforming. Residual salts remain active in the matrix in the same way that living plants use proteins to defend against mold.

The formulations of the present invention are unique because they are amino acid, protein based solutions that inhibit, remove and clean (i.e., clean, deodorize and sanitize) mold, and prevent mold from growing on a wide variety of types of surfaces, such as wood, cloth, polymeric, cement, glass, metal, drywall, ceramic, etc. When the formulations of the present invention are applied to surfaces, they kill mold and mold spores on contact and for days, months and years thereafter. To repeat, an important feature of the present invention is the ability of the various formulations to not only kill mold and other microbes but to prevent mold and microbes from returning to the treated surface. In this regard, the protein barrier film that remains on the treated surface is important in that it maintains the active mold-destroying components present and active on the surface for periods of time in excess of at least one year. This grow back prevention (i.e., mold inhibitor) feature of the invention is independent of which particular mold killing agent is included in the formulation.

The formulations of the invention can be applied to surfaces by spraying, misting, brushing, rolling or in any other manner useful to apply liquid to a surface. In forms other than liquid, the formulations can be applied by spreading them over the treated surface in any convenient manner.

Test Results:

Test #1:

Procedure: Sample of paper material that had been previously soaked in a solution of the formulation listed immediately above and then air-dried. The material was inoculated with known concentrations of MOLD, cultured at timed intervals, and incubated to determine the effectiveness of the material and solution on MOLD growth.

MOLD: Penicillium citrinum ATCC 9849
Initial Inoculum: 2,100 CFU

| | Time Intervals | |
|---|---|---|
| | After . . . | CFU recovered |
| Results: | 1 Minute | 430 |
| | 5 Minutes | 450 |
| | 10 Minutes | 440 |
| | 15 Minutes | 460 |
| | 30 Minutes | 330 |
| | 60 Minutes | 360 |
| | 4 Hours | 350 |
| | 6 Hours | 65 |
| | 24 Hours | 8 |

Results show reduction in MOLD growth over 24-hour period from 2,100 CFU to 8 CFU

MOLD: Aspergillus niger ATCC 6275
Initial Inoculum: 240 CFU

| | Time Intervals | |
|---|---|---|
| | After . . . | CFU recovered |
| Results: | 1 Minute | 110 |
| | 5 Minutes | 140 |
| | 10 Minutes | 60 |
| | 15 Minutes | 80 |
| | 30 Minutes | 80 |
| | 60 Minutes | 80 |
| | 4 Hours | 50 |
| | 6 Hours | 17 |
| | 24 Hours | <1 |

Results show reduction in MOLD growth over 24-hour period from 240 CFU to <1 CFU

Test #2

Sample Description: One (1) Liquid Solution of Formulation Listed Above in Spray Bottle

Procedure: Individual dishes with heavy growth of Aspergillus niger were sprayed to saturation with each separate solution, in triplicate. The plates were allowed to remain at room temperature, and tested at intervals of two (2) hours, seven (7) days, and thirty-five (35) days, with Rodac surface contact plates containing potato dextrose agar.

Results are as follows:

| | | Thirty-Five |
|---|---|---|
| Two (2) Hours | Seven (7) Days | (35) Days |
| No Growth | No Growth | No Growth |

Having described preferred embodiments of new and improved method and formulation for killing and preventing re-growth of mold, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A compound for remediating and inhibiting the growth of mold on a treated surface comprising:
a disinfectant for killing mold; and
a film-forming substance for forming a film layer on the treated surface for retaining the disinfectant in place on the surface.

2. The compound of claim 1 wherein said compound is in liquid form when applied to said surface, and wherein said film-forming substance is a tackifier that allows the disinfectant to adhere to the treated surface by forming said film to remain intact even if that surface is rubbed or scratched.

3. The compound of claim 2 wherein said tackifier is a complex formed from a protein and a saccharide.

4. The compound of claim 3 wherein said tackifier further includes an alkali metal or alkaline earth metal salt and an acid.

5. The compound of claim 4 wherein said tackifier is a prolamine, most preferably zein; the saccharide is a polysaccharide, most preferably guar gum; the salt is sodium chloride, most preferably sodium chloride with trace amounts of magnesium chloride and calcium chloride; and the acid is an organic acid, most preferably at least one of citric acid and ascorbic acid.

6. The compound of claim 2 wherein said tackifier is a prolamine.

7. The compound of claim 6 wherein said disinfectant comprises a combination of iodine and a bleach.

8. The compound of claim 7 wherein said bleach contains sodium hypochlorite.

9. A compound for remediating mold on a treated surface comprising a combination of iodine and a bleaching agent.

10. The compound of claim 9 wherein said bleaching agent contains sodium hypochlorite.

11. The compound of claim 10 further comprising a film-forming substance for forming a film layer on the treated surface for retaining the iodine and bleaching agent in place.

12. A method of treating a surface to kill and prevent further growth of mold thereon comprising the steps of:
(a) applying a mold killing disinfectant to the surface; and
(b) forming and adhering a film layer on the surface to retain the disinfectant on the surface.

13. The method of claim 12 wherein step (b) includes forming said film layer with a prolamine.

14. The method of claim 12 wherein steps (a) and (b) are performed by applying a liquid compound to said surface, the compound comprising said mold killing disinfectant and a film-forming substance.

15. The method of claim 14 further comprising the step of providing said disinfectant as a combination of iodine and a bleaching agent containing sodium hypochlorite.
